(19) United States
(12) Patent Application Publication
(10) Pub. No.: US 2025/0033287 A1
(43) Pub. Date: Jan. 30, 2025

(54) METHOD FOR PRODUCING AT LEAST ONE COMPONENT

(71) Applicant: ARBURG GMBH + CO KG, Lossburg (DE)

(72) Inventors: Martin NEFF, Lauterbach (DE); Uwe HELLSTERN, Lossburg (DE)

(21) Appl. No.: 18/706,972

(22) PCT Filed: Oct. 26, 2022
(86) PCT No.: PCT/EP2022/079889

§ 371 Date: May 2, 2024

(30) Foreign Application Priority Data
Nov. 3, 2021 (DE) 10 2021 128 639.5

(51) Int. Cl. B29C 64/386; B29C 64/336; B33Y 10/00; B33Y 50/00

(52) U.S. Cl. CPC B29C 64/386; B29C 64/336; B33Y 10/00; B33Y 50/00

(57) ABSTRACT

In a method for producing, by means of an additive manufacturing method or a 3D printing process, at least one component comprising at least two build materials each having a critical residence time T_x_max, data for producing the component are provided and the component is divided into at least one build portion having corresponding build portion information. After deriving at least one build material volume and at least one average removal rate per build portion from the build portion information, at least one build time per build portion and at least one resulting residence time t_x for each build material are calculated from the build material volume and the removal rate. The resulting residence times t_x are compared with the respective critical residence times T_x_max of the corresponding build materials. By virtue of the fact that at least one adaptation of the data is carried out. such that the respective resulting residence times t_x are less than the respective critical residence times T_x_max of the corresponding build materials, if at least one resulting residence time t_x exceeds the respective critical residence time T_x_max of the corresponding build material, this results in an optimization with regard to the consumption of the required build material and the quality of the component.

### REFERENCE TO RELATED APPLICATIONS

The present application relates to and claims the priority of German patent application 10 2021 128 639.5, filed on Nov. 3, 2021, the disclosure of which is hereby expressly made the subject matter of the present application in its entirety.

### TECHNICAL FIELD

The disclosure relates to a method for producing at least one component, a machine controller, a machine and a computer program product.

For the explanation of the disclosure, some terms are first defined as follows:

In the context of this application, a “resulting residence time” is understood to be the period of time during which a build material, e.g., a plastics material, a thermoplastic material or a support material is melted in a machine under thermal stress. For example, in a machine, e.g., a machine for processing plastics materials and other plasticizable materials, a production machine or a 3D-printing machine, a certain amount of build material is melted and remains in a heated nozzle at a temperature until the build material is discharged.

In the context of this application, a “critical residence time” is understood to be the period of time in which no degradation or thermal stress of the build material occurs as a result of the residence time. If this critical residence time is exceeded, degradation or thermal stress of the build material occurs. Depending on the temperature and the residence time, degradation or thermal stress of the build material and thus a physical and chemical structural change in the build material, e.g., a plastics material, a thermoplastic material or a support material, may be caused, which may result, for example, in changes in the flow properties and/or negative effects on the mechanical properties of the produced components. The longer the build material is exposed to this temperature, the lower the temperature at which degradation or thermal stress begins, i.e., at long residence times. As the rate of degradation or breakdown increases exponentially with temperature, the critical residence time is shortened at higher temperatures. Overall, a low respectively high temperature results in a long respectively short critical residence time. The critical residence time can also depend on the material itself, the chemistry and/or the pressure.

### BACKGROUND

Nowadays, a wide variety of components, for example for prototypes or small batches, can be produced in a 3D-printing process, for example in extruding or melting 3D-printing processes such as FDM (e.g., EP 1 886 793 B1). For this purpose, a certain amount of build material, e.g., a plastics material, a thermoplastic material or a support material, is melted and provided in a heated nozzle of a machine, e.g., a machine for processing plastics materials and other plasticizable materials, a production machine or a 3D-printing machine. The melted build material is initially subjected to thermal load in a heated nozzle. The component is then produced layer by layer using a 3D-printing machine, for example, by discharging build material from the nozzle. Depending on the size of the component, the production of the component takes a corresponding amount of time, with the production time generally scaling with the size of the component. If the build material remains at too high a temperature for too long, for example, this can lead to degradation or thermal stress of the build material, which may result in a physical and/or chemical structural change in the build material. This may, for example, lead to changes in the flow properties and/or negative effects on the mechanical properties of the produced components.

DE 10 2013 004 845 A1 discloses a state monitoring device for a resin, wherein the state monitoring device comprises a temperature detection unit and a resin deterioration state calculation unit. A warning output unit is used to output a warning if the deterioration state determined by the resin deterioration state calculation unit exceeds a predetermined limit value.

In prior-art 3D-printing processes, the melted build material provided is flushed out regardless of the actual residence time, which unnecessarily increases the amount of build material required. It may be that a certain build material is only needed for a short time for a small volume of a large component, so that the build material residing in the nozzle exceeds the critical residence time due to a long waiting time and thus leads to poor results when used, e.g., with regard to the quality of the component. If, for example, a large volume of another build material is discharged, the build material also resides in the nozzle for a long time, which can cause the critical residence time to be exceeded.

US 2020/0005224 A1 discloses oxidation induction times and residence times as well as different heating temperatures of the various materials from a database to prevent deterioration of the material. When injection settings are made, the residence times and oxidation induction times from the database are compared with each other and an automatic correction of the injection settings or conditions can be made.

Document JP 2016 159 481 A discloses, for the field of injection molding machines which are neither intended for additive manufacturing nor for 3D-printing, an injection molding machine having a controller, wherein the controller is configured to set a first residence time for regulating the residence time of the resin material in the heating cylinder and a second residence time which is longer than the first residence time. Further, the injection molding machine has a timer that counts a standby time from the time of execution of the previous injection operation to the time of execution of the next injection operation. When the standby time reaches the first residence time, the controller is configured to control a signaling device to notify the operator that the standby time is approaching the second residence time and to control the signaling device to flush the resin material retained by the operator in the heating cylinder by the operator and to prohibit operation of the injection molding machine until the flushing operation is completed.

JP 2004 001 403 A also discloses, in the field of injection molding machines, an injection molding machine for molding a molded product in which at least two kinds of resin materials having different compositions and colors are integrated.

Document EP 3 970 945 A1 discloses 3D-printing feedstocks containing filaments with separate layers or portions that can be produced by co-extrusion, microlayer co-extrusion or multi-component/fractal co-extrusion. The filaments enable the simultaneous deposition or combination of different materials through one or more nozzles during the 3D-printing process and enable smaller layer sizes in the milli, micro and nano range.

Document WO 2021/049935 A1 discloses a dispensing head for additive manufacturing with continuous-fiber-reinforced fused filaments. The dispensing head is configured to dispense a material onto a substrate support platform and comprises one or more inlets for receiving a strand of fusible solid material and a reinforcing fiber, and a material passageway extending from the receiving inlets to a dispensing outlet. The dispensing head further comprises a material heating unit for liquefying the material into a drive device for propelling the material through the material passages.

### BRIEF SUMMARY

The disclosure provide a method for producing at least one component which is optimized with regard to the consumption of the required build material and the quality of the component.

The features listed individually in the claims can be combined with one another in a technically feasible way and can be supplemented by explanatory facts from the description and by details from the Figures, wherein further variants of the disclosure are shown.

The method for producing at least one component comprising at least two build materials, e.g., plastics materials, thermoplastic materials or support materials, each with a critical residence time T_x_max, comprises the following steps. The component is produced using an additive manufacturing method or a 3D-printing process, e.g., in a layer-by-layer printing process (layer-by-layer method). The support materials can be removed from the component after the production process, e.g., a 3D-printing process, for example by breaking away (mechanical detachment) and/or by treatment with water and/or chemicals.

First of all, data for producing the component, such as CAD, geometry, machine, peripheral device, temperature, build material number, build material temperature and/or build material data are provided. Furthermore, the data can also include information about the machine used, e.g., a machine for processing plastics materials and other plasticizable materials, a production machine or a 3D-printing machine, peripheral devices used or information about, for example, the size and setting of the discharge nozzles. The data can, for example, be provided as a data set, in particular as a CAD data set, e.g., of a data preparation. However, the data can also, for example, be provided in full or in part separately to the data preparation.

The component is divided into at least one build portion, e.g., into one layer or a plurality of layers with corresponding build portion information. The build portion information can have similar information to the data for producing the component, e.g., information regarding the build material, the build material volume, the build material temperature, the build strategy, the production process and/or the machine used. The division can, for example, be performed automatically by the data preparation based on the data provided or after a selection by the operator. For example, it is preferably possible that the operator first selects a build strategy and then the component is divided into at least one corresponding build portion with corresponding build portion information. It is also possible for the build strategy to be selected automatically depending on the component. It is also possible that a requirement for build material, e.g., support material, is calculated when the component is divided into build portions.

At least one build material volume and at least one average discharge rate per build portion, e.g., per layer, is derived from the build portion information. Preferably, the at least one build material volume and the at least one average discharge rate per build portion are derived for each build material. Preferably, the build material volume and the average discharge rate for each build portion are dependent on the selected build strategy.

At least one build time per build portion and at least one resulting residence time t_x for each build material are calculated from the build material volume and the discharge rate per build portion. For example, the build material volume per build portion is required for build-portion-specific dosing. In order to advantageously not provide an unnecessarily large amount of build material and thus reduce the resulting residence time of the build material in the heated state, at least one, preferably each build material is only melted in accordance with the volume of build material required in the build portion shortly before the build material is deposited.

Preferably, it is also possible for the build material to be melted and/or provided discontinuously. For example, the build material can be prepared discontinuously in a plasticizing unit, preferably according to a corresponding specification regarding the volume, for example from a data set, and provided as a melt cushion. Preferably, it can be provided that only a corresponding volume of build material is to be melted for a specific build portion. The melt cushion is then emptied during the discharge process. Afterwards, “new” build material can be provided and/or melted again. The melted build material can then be fed into the nozzle as soon as build material has been discharged from the nozzle. The nozzle is therefore always filled with build material.

In a comparison, the resulting residence times are compared with the respective critical residence times of the corresponding build materials.

In order to advantageously achieve an optimization with regard to the consumption of the required build material and the quality of the component, at least one adaptation of the data is made so that the respective resulting residence times t_x are less than the respective critical residence times T_x_max of the corresponding build materials if at least one resulting residence time t_x exceeds the respective critical residence time T_x_max of the corresponding build material.

The adaptation can, for example, take the form of an adapted data set. For example, the adapted data set can be sent to the machine as a machine-readable code, e.g., as a G-code, in order to manufacture it in a process-specific manner. For example, the G-code contains the respective NC data for moving the axes as well as the instructions for depositing the build material. In addition, the calculated data for the build-portion-specific volume and the calculated residence time can be included. The adapted data can, for example, be transferred to a machine controller and/or the machine, the controller of which then continues to operate the corresponding construction progress with the adapted data. The data are then used to produce the component.

Preferably, at least one of the above-mentioned steps is carried out before the first production of the component, which advantageously makes it possible to plan the production process better and save build material.

For an advantageously effective saving in the consumption of build material, the adaptation is preferably carried out in such a way that at least one build portion and/or the corresponding build portion information is changed. For example, the size of the layers and/or build portions can be changed, divided or otherwise split. The adaptation can be carried out by the data preparation, for example. It is also possible that the data preparation performs the adaptation automatically or that the operator selects and/or adapts a build portion to be adapted and the corresponding build portion information.

If, for example, it is not possible to change the temperature of the build materials and advantageously prevent degradation or thermal stress of the build materials, the adaptation is preferably carried out by changing at least one resulting residence time t_x. Preferably, the resulting residence times t_x of all build materials are changed. This can be achieved, for example, by discharging the build material at a less relevant point in and/or on the component or at another point so that the build material cannot remain for too long and thus advantageously no degradation or thermal stress occurs. By discharging the build material, “fresh” or thermally unloaded build material is thus provided and made available earlier. By discharging the build material from the nozzle, “fresh” or thermally unloaded build material is melted and provided in the nozzle and the thermally stressed build material can still be used advantageously. The resulting residence time t_x is reduced in this case, preferably set to zero.

When a component is manufactured, it may be that a certain build material is only required at the outset and then again towards the end of the production process, for example. However, the build material is under thermal load the entire time, so that the build material could exhibit degradation or thermal pre-load, at least towards the end, as it has not been used and/or discharged over a longer period of time in the middle of the production process. The residence time is therefore correspondingly high. In order to advantageously reduce or prevent the degradation or thermal pre-load, the resulting residence time t_x is preferably changed, preferably reduced, by producing at least one additional element. The additional element has at least one build material, but can also be made from a plurality of build materials. By producing the additional element, build material is used or discharged at shorter intervals, so that “fresh” or thermally unloaded build material is available at shorter intervals and thus the resulting residence time t_x is reduced, as the build material is discharged “faster” or more often.

Preferably, the additional element is at least one further component, which is further preferably at least partially inverse to the component to be produced. If, for example, for the sake of simplicity, a component built up in layers consists of a build material A and a build material B, wherein the build material B can also be a support material, for example, and wherein only the build material A is used at the beginning and towards the end, the corresponding component would look like the following, for example: ABA. In this example, the first layer consists of build material A, the second layer of build material B and the third layer of build material A again. A corresponding further (inverse) component BAB is produced so that the build material A is also used between the start and end of the production process, which advantageously prevents degradation or thermal stress of the build material A.

Preferably, the build materials have a resulting residence time t_x of substantially zero, as they are used over the entire build time either on the component itself or on the additional element or the further component. Advantageously, this results in substantially no degradation or thermal stress of the build material.

In order to advantageously ensure that the component is constructed exclusively from build material that has not been thermally (pre)loaded, if the build material has already been degraded or thermally stressed, the build material is preferably deposited in at least one build portion, preferably in each build portion first on the additional element. In the event of degradation or thermal stress of the build material, the degraded or thermally stressed build material is used first on the additional element so that “fresh” or non-degraded or thermally stressed build material is available again for the “correct” component. Degraded or thermally stressed build material can therefore be used or discharged from the additional element to make room for “fresh” or thermally unloaded build material.

The additional element can preferably be configured as at least one part of the component. The additional element can also preferably be implemented in the component. Advantageously, this means that no further or additional component is produced, which saves time. Advantageously, less build material is thus discharged and the build time and the residence time of all build materials are not increased accordingly. The resulting residence time of the other build materials is also advantageously not increased. For example, the additional element can be added in the region of a support structure or a support geometry, or the additional element can be implemented in the support structure or the support geometry or can form the latter, wherein the additional element comprises at least one build material.

In order to advantageously obtain the desired component, the additional element is preferably removed after the component has been produced. For example, it is thus possible to remove the support structure manufactured with a support material and the additional element embedded therein together after the production process. The additional element can be removed, for example, by treating it with water and/or chemicals and/or by breaking it away (mechanical removal).

During a production process, e.g., a 3D-printing process, it may be that, for example, no additional element and/or further component can be manufactured, as this would, for example, represent too high a consumption of build material. In order to prevent degradation or thermal stress, the adaptation is preferably carried out in such a way that at least one critical residence time T_x_max is changed, preferably increased. In principle, it is preferably conceivable that all critical residence times of all build materials are changed. The critical residence time T_x_max of the build material depends, inter alia for example, on the build material itself, on the chemistry and on the temperature. For example, a different build material could be used, chemical additives and/or stabilizers could be added to the build material or the temperature of the build materials could be varied. For example, the respective temperature of the nozzle can be lowered to a non-critical temperature in the case of very different build material distributions and long building tasks, so that a longer critical residence time T_x_max is realized without degradation or thermal stress. For example, it is also possible to heat a build material to a correspondingly high temperature just before the build material is deposited, e.g., in an upper layer of the component. In addition, the temperature of a build material can be lowered after the first layers, for example, when the build material is no longer required for the subsequent layers.

The critical residence time T_x_max depends, among other things, on the temperature. If the temperature of the build material in question is preferably lowered, the critical residence time is advantageously greater overall or tends towards infinity for certain temperatures. This means that at this particular temperature, degradation or thermal stress of the build material advantageously does not occur. Preferably, the critical residence time T_x_max is thus changed, preferably increased, by changing, preferably reducing, the temperature of at least one build material for at least a certain period of time. Further preferably, the temperature is changed during, before and/or after production of the component.

In order to avoid providing an unnecessarily large amount of build material and thus reduce the resulting residence time in the heated state, each build material is preferably only provided and melted in accordance with the volume required in the build portion shortly before the build material is deposited.

For an advantageously low consumption of build material, several adaptations are preferably combined with each other. For example, in the case of an unfavorable distribution of build material in a multi-build-material component, the temperature of the build materials of the component can be changed, resulting in a longer critical residence time T_x_max, and at least one additional element, for example in the support structure of the component, can be added and/or implemented at the same time, thus yielding a shorter resulting residence time t_x. Preferably, at least two adaptations can take effect simultaneously.

In order to advantageously prevent degradation or thermal stress during the production of the component, at least one monitoring of the resulting residence times t_x and/or the flow properties of the build materials, e.g., the process pressure or the build material viscosity, is carried out during the production process. For example, the ACTUAL data of the machine are continuously compared with the TARGET data of the data preparation using a controller and adapted if necessary. It is also conceivable that several different monitoring processes are carried out.

Preferably, if at least one resulting residence time is exceeded compared to the corresponding critical residence time of at least one build material and/or if the flow properties, e.g., the process pressure or the build material viscosity of at least one build material, change, the corresponding build material is discharged and/or new build material is provided and/or prepared.

If, for example, it is registered that of the build materials A, B and C, the build materials A and C each have a higher resulting residence time than the corresponding critical residence time and/or their flow properties change, for example compared to the flow properties at the start of the production process, the build materials A and C are discharged and new or thermally unloaded build materials A and C are provided and/or prepared. Advantageously, the resulting residence time t_x is reduced or preferably starts again at zero (t_x=0). For example, the build material can be discharged and new build material can be provided and/or processed by a machine controller. Preferably, the thermally stressed build material is discharged before the new build material is provided and/or processed. For example, the building process can preferably be interrupted for this purpose. However, it is also more preferably possible for the thermally stressed build material to be discharged while another build material is being used, which advantageously saves time.

Preferably, if at least one resulting residence time exceeds the corresponding critical residence time of a build material and/or if there is a change in the flow properties, at least one flushing process is initiated. The flushing process can, for example, take place automatically by means of a flushing station or manually by discharging into a corresponding collecting container.

A machine controller for a machine for processing plastics materials and other plasticizable materials, in particular for a 3D-printing machine. Is provided for an advantageous optimization with regard to the consumption of the required build material and the quality of the component. The machine controller is set up, configured and constructed to carry out the method described above.

A machine for processing plastics materials and other plasticizable materials, in particular a 3D-printing machine is provided for an advantageous optimization with regard to the consumption of the required build material and the quality of the component, the machine being set up, configured and/or constructed to carry out the method described above.

A computer program product is stored with a program code on a computer-readable medium for carrying out the method described above in order to optimize the consumption of the required build material and the quality of the component.

Further advantages can be found in the following disclosure of a preferred exemplary embodiments. The features listed individually in the claims can be combined with one another in a technically feasible way and can be supplemented by explanatory facts from the description and by details from the Figures, wherein further variants of the disclosure are shown.

### BRIEF DESCRIPTION OF THE FIGURES

In the following, the disclosure is explained in greater detail with reference to an exemplary embodiment shown in the attached Figures, in which:

FIG. 1 shows a flow chart,

FIGS. 2-4 show alternatives of a component and a further component (inverse component),

FIG. 5 shows a component and a component with additional elements,

FIG. 6 shows a component,

FIG. 7 shows a component and a component with additional elements,

FIGS. 8a, 8b show flow charts.

### DETAILED DESCRIPTION

The disclosure will now be explained in greater detail by way of example with reference to the attached drawings. However, the embodiments are only examples and are not intended to limit the inventive concept to a particular arrangement.

Before describing the disclosure in detail, it should be noted that it is not limited to the respective components of the device and the respective method steps, as these components and methods may vary. The terms used herein are merely intended to describe particular embodiments and are not used in a limiting manner. Furthermore, when the singular or indefinite articles are used in the description or in the claims, this also refers to the plurality of these elements, unless the overall context clearly indicates otherwise.

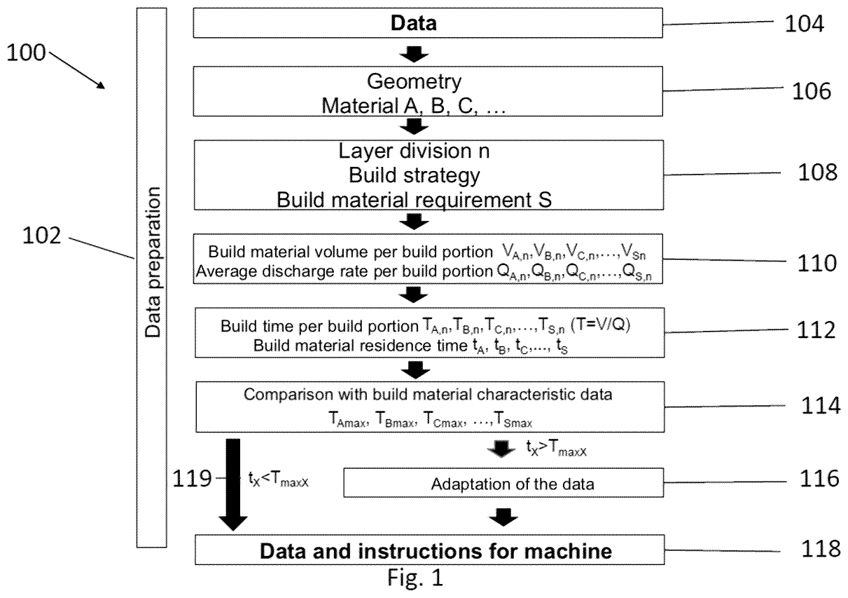

FIG. 1 shows a flow chart 100 which illustrates the sequence of a method for producing at least one component in an additive method or in a 3D-printing process, comprising at least two build materials, e.g., plastics materials, thermoplastic materials or support materials, each with a critical residence time T_x_max. In a data preparation 102, in a step 106, data 104 for producing the component, such as CAD data, geometry data, machine data, peripheral device data, temperature data, build material number data, build material temperature data or build material data are provided. Further, the data may also include information about the machine used, for example, a machine for processing plastics materials and other plasticizable materials, a production machine or a 3D-printing machine, peripheral devices or information about, for example, the size of the discharge nozzles. The data 104 may, for example, be provided as a data set, for example as a CAD data set of a data preparation 102, a machine controller and/or a machine. However, the data 104 may also be provided, for example, separately to the data preparation 102.

In a step 108, the component is divided by the data preparation into at least one build portion, for example into one layer or a plurality of layers n with corresponding build portion information. The division can, for example, be performed automatically by the data preparation or depending on a selection by the operator. In a further preferred exemplary embodiment, it is also possible that the operator first selects a build strategy and the component is then divided into at least one corresponding build portion with corresponding build portion information. It is also possible for the build strategy to be selected automatically depending on the component. In a further preferred exemplary embodiment, it is also possible for a requirement S for build material, e.g., support material, to be calculated when the component is divided into build portions.

In a step 110, at least one build material volume and at least one average discharge rate per build portion, e.g., per layer, is derived from the build portion information. Preferably, the corresponding build material volume (e.g., V_A_n, V_B_n, V_C_n, . . . , V_S_n) and the corresponding average discharge rate (e.g., Q_A_n, Q_B_n, Q_C_n, . . . , Q_S_n) per build portion are derived for each build material. The build material volume and the average discharge rate per build portion are preferably dependent on the selected build strategy.

The calculation of at least one build time (e.g., T_A_n, T_B_n, T_C_n, . . . , T_S_n) per build portion and at least one resulting residence time t_x for each build material (e.g., t_A, t_B, t_C, . . . , t_S) from the build material volume and the discharge rate is carried out in a step 112. The volume of build material per build portion is required, for example, for build-portion-specific dosing. In order to advantageously not provide an unnecessarily large amount of build material and thus reduce the resulting residence time of the build material in the heated state, the build material is only melted shortly before the build material is deposited in accordance with the volume of build material required in the build portion.

In a step 114, the resulting residence times t_x (e.g., t_A, t_B, t_C, . . . , t_S) are compared with the respective critical residence times T_x_max of the corresponding build materials (e.g., T_A_max, T_B_max, T_C_max, . . . , T_S_max). If the comparison shows that the resulting residence times t_x of the respective build materials are less than the respective critical residence times T_x_max, the production process is not adapted. The data can then be transferred in a step 119, e.g., from the data preparation to a machine controller or to a machine, e.g., a machine for processing plastics materials and other plasticizable materials, a production machine or a 3D-printing machine. The data can then be used to produce the component.

If the comparison reveals that at least one resulting residence time t_x exceeds the respective critical residence time T_x_max of the corresponding build material, the data 104 are adapted in step 116 so that the respective resulting residence times t_x are less than the respective critical residence times T_x_max of the corresponding build materials. The data are then used in a step 118 to produce the component.

In a preferred exemplary embodiment, the adaptation of the data 104 is performed such that at least one build portion and/or the corresponding build portion information are adapted, for example by the data preparation 102.

Advantageously, the data set can therefore be adapted accordingly or machine commands can be added to change the build portion information. However, if it is still not possible to exceed a residence time due to the data situation—because, for example, a material is not discharged over a plurality of layers—a temperature reduction can additionally be specified. This requires that the residence time of the material is not only calculated for one layer, but over a plurality of layers. Lastly, if the specified residence time on the machine is unexpectedly exceeded during production despite the measures initiated in advance, a flushing process can be initiated. In addition to the movement commands, the required amount of material that must be provided per layer can also be specified in the build portion information.

In order to advantageously avoid degradation or thermal stress of the build material, in a preferred exemplary embodiment the data 104 are adapted in such a way that at least one resulting residence time t_x is changed. Due to the preferably shortened resulting residence time t_x, the build material is under thermal stress for a shorter period of time, which prevents degradation.

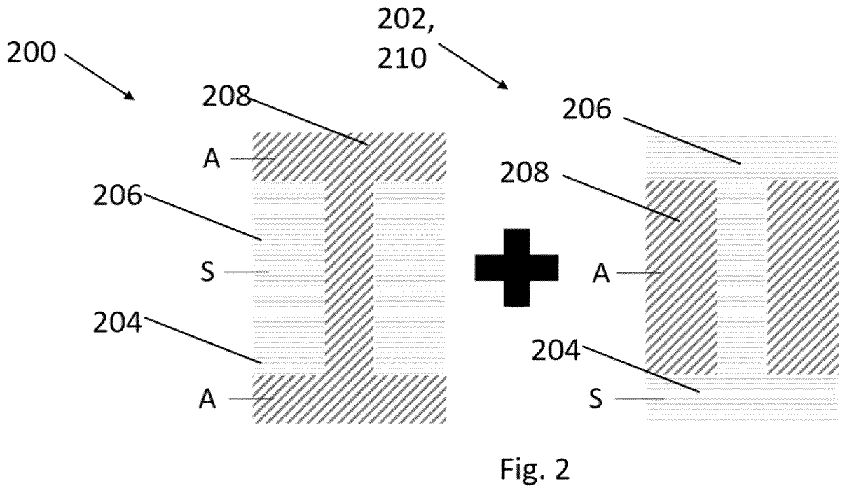

In the preferred exemplary embodiments in FIGS. 2 to 5, the resulting residence time t_x is changed, preferably reduced, by producing at least one additional element 210.

In the exemplary embodiment in FIG. 2, a component 200 is shown on the left-hand side and is constructed of two build materials 206 (S), 208 (A). The change in the resulting residence time t_x takes place in FIG. 2 in such a way that at least one additional element 210 is produced. In FIG. 2, the additional element 210 is a further component 202 (inverse component) which is at least partially inverse to the component 200. The further component 202 (inverse component) is shown on the right-hand side in FIG. 2. In principle, the left-hand component in FIG. 2 could also represent the other component 202 (inverse component). In this case, the component on the right-hand side would be the “correct” component.

Preferably, both build materials are discharged in FIG. 2. Advantageously, none of the build materials “stands” longer, which would increase the critical residence time. For example, in the exemplary embodiment in FIG. 2, the component 200 and the further component 202 are preferably produced in such a way that, for example, at least one build portion, e.g., one layer 204, preferably a plurality of layers, are discharged layer-by-layer from the bottom to the top. It can be seen from FIG. 2 that in a first (bottom) layer, both build materials 208 (A) and 206 (S) were discharged for the same length or at the same frequency, or the same volume was discharged for each of the build materials 208 (A) and 206 (S). On one occasion, the build material 208 (A) was discharged in the first (lowest) layer of the component 200 (left side) and, on another occasion, the build material 206 (S) was discharged just as frequently in the first (lowest) layer of the other component 202 (right side). The discharged volumes of the two build materials 208 (A) and 206 (S) in FIG. 2 are thus preferably the same for the component 200 and for the further component 202 taken together. In principle, however, the discharged volumes can also be different. Fundamentally, the fact is that both build materials are discharged and neither of the build materials “stands” for longer, wherein the residence time is increased. For example, the build materials can be discharged at different critical residence times at different frequencies

Preferably, in the production of the component 200 and the further component 202 together, the total volume of the component 200 is consumed per build material. The volume of the build material 206 (S) of the component 200 and the further component 202 corresponds to the volume of the build material 208 (A) of the component 200 and the further component 202, which also results in an equal build time of the build materials 206 (S) and 208 (A), assuming an equal average discharge rate per layer in FIG. 2. The resulting residence time t_x of the build materials 206 (S) and 208 (A) is likewise equal or substantially equal to zero in the case of parallel production of the components 200 and 202 in the exemplary embodiment in FIG. 2, since both build materials 206 (S) and 208 (A) are continuously in use over the entire production process.

In the exemplary embodiment in FIG. 2, the build material is preferably deposited in at least one build portion, preferably in each build portion first on the additional element 210 or on the further component 202. First, the first layers with the build material 206 (S) for the further component 202 are discharged until the build material 208 (A) for the further component 202 has been discharged at least once for a certain time in the production process. After a certain time or after a certain discharge of the build material 208 (A) for the further component 202, for example after a layer 204, the component 200 or, in FIG. 2, the first layer 204 of the component 200 with the build material 208 (A) is then discharged. This can advantageously ensure that the component 200 is constructed exclusively from build material that is not thermally stressed. The further component 202 practically serves to discharge thermally stressed build material so that the component 200 can be constructed from build material that is not thermally stressed. Therefore, the shape of the further component 202 is, in principle, arbitrary.

In a further preferred exemplary embodiment, the discharge of the build materials 206 (S) and 208 (A) can also take place simultaneously or in parallel, since, for example, a separate discharge nozzle can be provided per build material 206 (S), 208 (A). Further preferably, the component 200 and the further component 202 can be produced simultaneously. In this case, the component 200 and the further component 202 are preferably produced at a spacing from one another, since the discharge nozzles are spaced apart from one another.

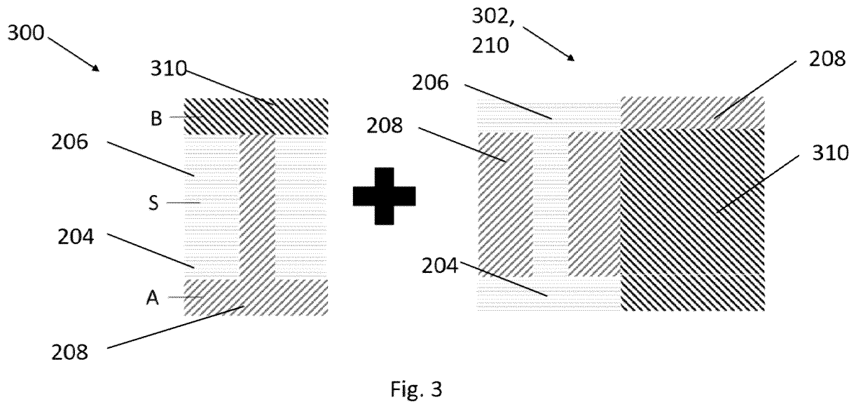

In a further exemplary embodiment according to FIG. 3, a component 300 is shown on the left-hand side and is constructed of three build materials 206 (S), 208 (A) and 310 (B). On the right-hand side, the corresponding further component 302 (inverse component) is shown, which in FIG. 3 is approximately twice as large as the component 300. In principle, the further component 302 can also be divided into a plurality of components. Here too, the component 300 and/or the further component 302 can be constructed from at least one layer 204, preferably from a plurality of layers, e.g., layer 204 for layer 204. The respective discharged volumes of the three build materials 206 (S), 208 (A) and 310 (B), i.e., the component 300 and the further component 302 taken together, are the same overall and correspond to the volume of the component 300 in FIG. 3, so that the same build time of the three build materials 206 (S), 208 (A) and 310 (B) results, assuming the same average discharge rate per layer in each case. Also, in the case of a parallel production of the components 300 and 302 in the exemplary embodiment according to FIG. 3, the resulting residence time t_x of the build materials 206 (S), 208 (A) and 310 (B) is equal or essentially equal to zero, since the build materials 206 (S), 208 (A) and 310 (B) are continuously in use over the entire 3D-printing process.

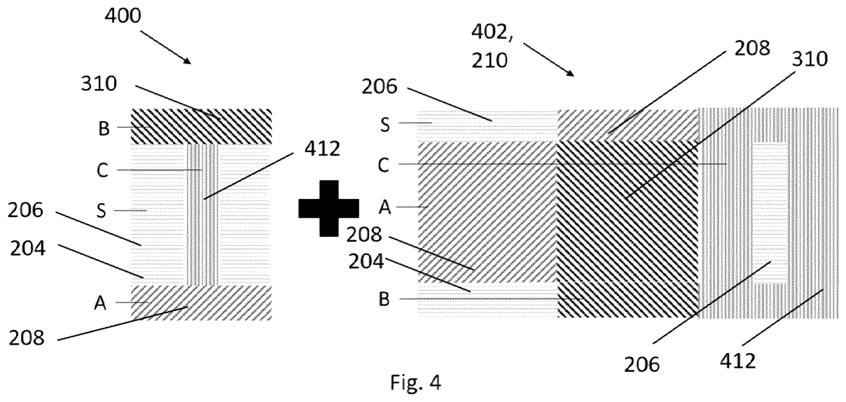

As already shown for the exemplary embodiments in FIGS. 2 and 3, the same applies also to a further preferred exemplary embodiment according to FIG. 4. In FIG. 4, a component 400 is shown on the left-hand side, which is constructed from four build materials 208 (A), 206 (S), 310 (B) and 412 (C). On the right-hand side, the additional element 210 or a further component 402 is shown, which is approximately three times the size of the component 400. Here too, the component 400 and/or the further component 402 can be constructed in layers from at least one layer 204, preferably from a plurality of layers. As in the exemplary embodiments in FIG. 2 and FIG. 3, the volumes of the four build materials 208 (A), 206 (S), 310 (B) and 412 (C) taken together are also the same in the exemplary embodiment according to FIG. 4, so that the same build time results for the four build materials 208 (A), 206 (S), 310 (B) and 412 (C), assuming the same average discharge rate per layer in each case. Also, in the case of a parallel production of the components 400 and 402 in the exemplary embodiment according to FIG. 4, the resulting residence time t_x of the build materials 208 (A), 206 (S), 310 (B) and 412 (C) is equal or substantially equal to zero, since the build materials 208 (A), 206 (S), 310 (B) and 412 (C) are continuously in use over the entire 3D-printing process. In principle, the component can comprise any number of build materials. If more build materials are used in further exemplary embodiments, the size of the further component increases accordingly.

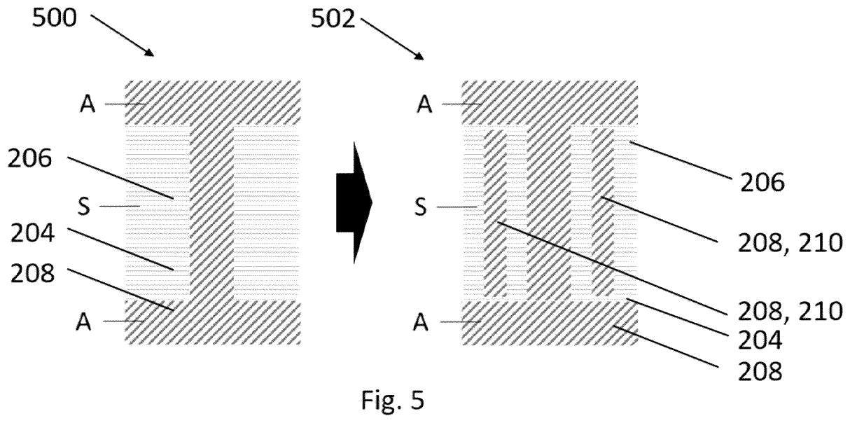

In a further preferred exemplary embodiment according to FIG. 5, a component 500 is shown on the left-hand side, which is constructed from two build materials 206 (S) and 208 (A) and corresponds to the component 200 of FIG. 2. The build material 206 (S) can, for example, be a support material that can be removed after the production process. The component 500 is constructed from at least one layer 204, preferably from a plurality of layers, in an additive manufacturing method or a 3D-printing process, e.g., in a layer-by-layer printing process (layer-by-layer method). At least one additional element 210 is implemented in the component 500 in FIG. 5, e.g., in a support structure consisting of the build material 206 (S). The result is shown on the right-hand side in FIG. 5 as component 502 with two additional elements 210. In FIG. 5, two additional elements 210 consisting of the build material 208 (A) have been implemented on the left-hand side of the component 500 and can be removed together with the build material 206 (S) after the production process. The build material 208 (A) is thus used or discharged more frequently due to the implementation of the additional elements 210, so that an overall shorter residence time of the build material 208 (A) is advantageously achieved. The additional elements 210 in FIG. 5 also advantageously have an additional task as a support structure during the production process, since this stabilizes the entire component 502.

In principle, the shape of the additional elements 210 is arbitrary. What is important is that the corresponding build material is used or discharged, thus shortening the resulting residence time t_x. In other words, in the exemplary embodiment in FIG. 5, only the build material 208 (A) is used in the lower layers of the component 500. In the middle region of the component 500, less build material 208 (A) is used, and more build material 206 (S) is used. Therefore, it may be that the build material 208 (A) “stands” for a long time and the resulting residence time of the build material 208 (A) increases accordingly and becomes greater than the critical residence time. The reason for this is that little material is discharged and thus remains longer in the thermally loaded state, which increases the resulting residence time of the build material 208 (A). Therefore, in the exemplary embodiment in FIG. 5, two additional elements 210 are implemented on the right-hand side in the build material 206 (S) of the component 502. This reduces the residence time of the build material 208 (A), since the build material 208 (A) is in use at shorter intervals. Further, the build material 208 (A) is advantageously also used in a useful manner, for example as a support structure.

In a further preferred exemplary embodiment according to FIG. 5, the additional element 210 is removed after the component 502 has been produced. In FIG. 5, the build material 206 (S) surrounding the additional elements 210 is a support material that can be removed after the production process, for example by treatment with water and/or chemicals and/or by breaking away (mechanical removal). By removing the build material 206 (S), the additional elements 210 embedded therein are also removed.

In a further preferred exemplary embodiment, the adaptation is carried out such that at least one critical residence time T_x_max is changed. The critical residence time T_x_max of the build material depends, among other things, on the build material itself, on the chemistry and on the temperature. For example, a different build material could be used, chemical additives and/or stabilizers could be added to the build material or the temperature could be varied. If, for example, the temperature of the respective build material is lowered, the critical residence time T_x_max increases. Preferably, this approaches infinity for an appropriate temperature so that no degradation or thermal pre-load can occur.

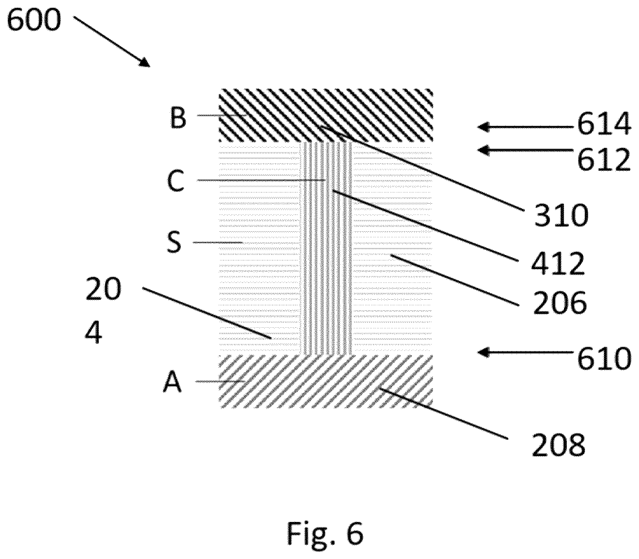

In a further exemplary embodiment according to FIG. 6, the critical residence time T_x_max is changed by changing, preferably lowering, the temperature of at least one build material for at least a certain period of time. FIG. 6 shows a component 600 which is constructed of four build materials 310 (B), 412 (C), 206 (S) and 208 (A) and corresponds to the component 400 from FIG. 4. The component 600 in FIG. 6 is constructed from a plurality of layers, layer by layer from bottom to top. In FIG. 6, the temperature of the build material 208 (A) is lowered at a point in time 610, since the build material 208 (A) is no longer required for the rest of the 3D-printing process. Preferably, the temperatures of the build materials 412 (C) and 206 (S) are increased to a corresponding temperature beforehand, since these build materials were not previously required.

For example, the particular temperature of the build material or the corresponding nozzle can be reduced to a non-critical temperature if the build material distributions and long building tasks are too different, so that a longer resulting residence time is realized without material degradation or the critical residence time is greater, preferably approaching infinity. At a point in time 614, the temperatures of the build materials 412 (C) and 206 (S) are reduced, as these are also no longer required. The temperatures are correspondingly low, so that the critical residence time T_x_max is correspondingly large, preferably approaching infinity. At a point in time 612, the temperature of the build material 310 (B) is preferably increased, since the build material 310 (B) was not required until later in the production of the component 600, but was not required beforehand. Since the build material 310 (B) is subsequently used for the entire remaining time, the resulting residence time of the build material 310 (B) is preferably less than the critical residence time T_x_max of the build material 310 (B) despite the temperature increase of the build material 310 (B), so that no degradation or thermal stress of the build material 310 (B) occurs.

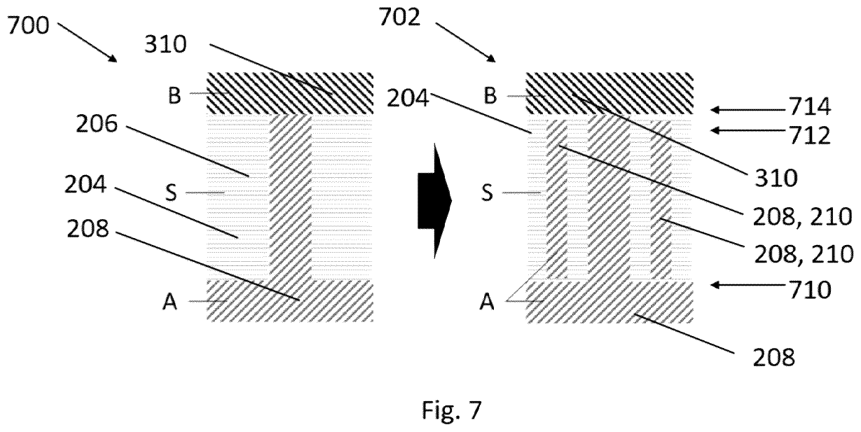

In a further exemplary embodiment according to FIG. 7, several adaptations are combined with each other. In FIG. 7, a component 700 is shown on the left-hand side, which is constructed from three build materials 208 (A), 206 (S) and 310 (B) and corresponds to the component 300 from FIG. 3. Similarly to the component 300 from FIG. 3, the component 700 in FIG. 7 is also constructed from a plurality of layers or in layers from bottom to top. The component 700 is adapted in such a way that at least one additional element 210 is added to the component 700, as already explained above with reference to FIG. 5. The result is shown on the right-hand side in FIG. 7 as component 702. The component 702 has two additional elements 210 consisting of the build material 208 (A). Preferably, the build material 206 (S) surrounding the additional elements 210 is a support material that can be removed after the production process with the additional elements 210 embedded therein. A further adaptation corresponding to the right-hand side in FIG. 7 is made in that, for example, the temperature of the build material 206 (S) or the temperature of the build material 310 (B) is only increased at a time 710 or at a time 712, as these are not required beforehand (see also exemplary embodiment according to FIG. 6). At a time 714, the temperatures of the build materials 208 (A) and 206 (S) no longer required are lowered so that their critical residence time T_x_max is increased, preferably towards infinity.

In FIG. 7, two adaptations are thus made on the right-hand side. Firstly, additional elements 210 are added to the component 700, whereby the resulting residence time t_x of the build material 208 (A) is changed or shortened, since it is discharged at shorter intervals due to the additional elements 210. On the other hand, the critical residence times T_x_max are changed, for example by increasing the temperature of the build material 310 (B) only at time 712 or lowering the temperatures of the build materials 208 (A) and/or 206 (S) at times 710 and 714, respectively, and thus changing or increasing the critical residence times.

In order to prevent degradation or thermal pre-load during production, different process monitoring systems are preferably available. ACTUAL data from the machine are continuously compared with the TARGET data from the data preparation using a controller and adapted if necessary. In another preferred exemplary embodiment, at least one monitoring of the resulting residence times and/or the flow properties of the build materials, e.g., process pressures or build material viscosity, is preferably carried out during the production of the component. For example, the actual build time of the build materials for each build portion is compared with the build time calculated from the data preparation per build portion. If there is degradation or thermal stress of the material, the flow properties change and deviations or fluctuations occur, e.g., in the process pressure, and can be detected by the machine or its measuring sensors.

If at least one resulting residence time exceeds the corresponding critical residence time of a build material and/or if the flow properties, e.g., the process pressure or the build material viscosity of at least one build material, change, the corresponding resulting residence time t_x is reduced in a further preferred exemplary embodiment by providing and/or preparing new build material.

In a further preferred exemplary embodiment, if at least one resulting residence time exceeds the corresponding critical residence time of a build material and/or if the flow properties change, the corresponding build material is discharged, e.g., in an additional element 210 and/or new build material is provided and/or prepared. Preferably, the preparation and/or provision of the new build material takes place following the discharge.

In a further preferred exemplary embodiment, at least one flushing process is initiated if at least one resulting residence time exceeds the corresponding critical residence time of a build material and/or if the flow properties change.

If, for example, deviations are detected during the building process, e.g., in the build time per build portion, in the process pressure or in the build material viscosity, different methods are used depending on the machine's equipment. If there is a flushing station, for example, a flushing process is initiated so that degraded or thermally stressed build material can be flushed out. If there is no flushing station, for example, the construction process is interrupted and the operator is requested to manually collect the thermally pre-damaged build material in an appropriate container. In principle, it is also possible that the building process is not interrupted and the thermally stressed build material is flushed out while other build materials are in use. This can preferably be done automatically, e.g., controlled by the machine controller.

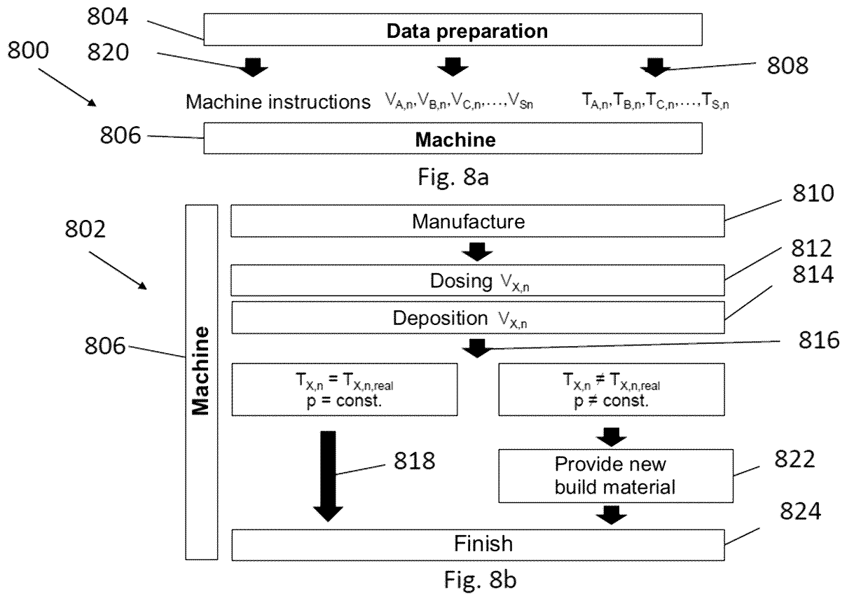

In an exemplary embodiment in FIG. 8a, a flow diagram 800 is shown. A machine 806, e.g., a machine for processing plastics and other plasticizable materials, a production machine or a 3D-printing machine, is provided there with data, e.g., relating to the build material volume, the build material temperature and/or the build time per build portion, by a data preparation 804 in a step 808. In principle, other data, e.g., CAD, geometry, machine, peripheral device, temperature, build material number, build material temperature or build material data can also be provided. In FIG. 8a, the data are transmitted to the machine 806 as machine instructions 820.

In FIG. 8b, a flow diagram 802 is shown according to a further exemplary embodiment. In a step 810, the machine 806 starts producing the component, for example with the data 808 and/or machine instructions 820 provided in FIG. 8a. In a step 812, the build material is dosed on the basis of the data regarding the build material volume per build portion. In a step 814, the build material is deposited accordingly in order to manufacture the component. Preferably, during the production of the component in a step 816, the actual build times T_x, n, actual per build portion of the individual build materials are monitored with the calculated build times per build portion and/or the process pressure p. This can, for example, compare and/or monitor the actual build time for each build portion with the calculated build time per build portion. If there is degradation or thermal stress of the material, the flow properties change and deviations or fluctuations occur, e.g., in the process pressure.

If there is no significant deviation, e.g., the actual build times substantially correspond to the calculated build times and the process pressure is constant, manufacture is completed in a step 818.

However, if there is a deviation, for example due to different actual build times or a non-constant process pressure, various options are provided in FIG. 8b, depending on the existing equipment of the machine. In a step 822, if at least one resulting residence time t_x exceeds the corresponding critical residence time T_x_max of a build material and/or if the flow properties of a build material change, the resulting residence time t_x is reduced by providing and/or preparing new build material.

In another preferred exemplary embodiment, the corresponding build material is discharged before the new build material is provided and/or prepared.

If, for example, a flushing station is present, at least one flushing process can be initiated in another preferred exemplary embodiment so that degraded or thermally stressed build material can be flushed out.

If no flushing station is present, in a further preferred exemplary embodiment the flushing process can be carried out manually or, for example, the machine instructions 820 can be processed and the provided build material can be discharged, for example, implemented in an additional element 210, for example as a support geometry.

In a further exemplary embodiment, a machine controller for a machine for processing plastics materials and other plasticizable materials, in particular for a 3D-printing machine, is disclosed, which is set up, configured and/or constructed to carry out at least one of the methods described above while achieving the stated advantages.

A machine for processing plastics materials and other plasticizable materials, in particular a 3D-printing machine, is disclosed in a further exemplary embodiment and is set up, configured and/or constructed to carry out at least one of the methods described above while achieving the aforementioned advantages.

A further exemplary embodiment is a computer program product comprising a program code stored on a computer-readable medium for carrying out at least one of the methods described above while achieving the stated advantages.

It goes without saying that this description may be subject to a wide range of modifications, amendments and adaptations that are within the range of equivalents to the appended claims.

1. A method for producing at least one component by means of an additive manufacturing method or a 3D-printing process, comprising at least two build materials wherein the build materials are melted and each build material is provided in a respective nozzle, each build material having a critical residence time T_x_max in which no degradation or thermal stress of the build material occurs as a result of a residence time, said method comprising the steps of:
providing data for producing the component,
dividing the component into at least one build portion having corresponding build portion information,
deriving at least one build material volume and at least one average discharge rate per build portion from the build portion information,
calculating at least one build time per build portion and at least one resulting residence time t_x for each build material from the build material volume and the discharge rate, wherein the resulting residence time t_x is the time, during which a build material is melted and remains in a heated nozzle at a temperature until the build material is discharged,
comparing the resulting residence times t_x with the respective critical residence times T_x_max of the build materials,
carrying out at least one adaptation of the data, such that the respective resulting residence times t_x are less than the respective critical residence times T_x_max of the build materials, if at least one resulting residence time t_x exceeds the respective critical residence time T_x_max of the corresponding build material,
using the data to produce the component.

2. The method according to claim 1, wherein the adaptation is carried out in such a way that at least one of the at least one build portion and the build portion information are changed.

3. The method according to claim 1, wherein the adaptation is carried out such that at least one resulting residence time t_x is changed.

4. The method according to claim 3, wherein the resulting residence time t_x is reduced by producing at least one additional element.

5. The method according to claim 4, wherein the additional element is at least one further component which is at least partially inverse to the component.

6. The method according to claim 4, wherein a build material is deposited in at least one build portion first on the additional element.

7. The method according to claim 4, wherein the additional element is implemented in the component or is removed after the component has been produced.

8. The method according to claim 1, wherein the adaptation is carried out such that at least one critical residence time T_x_max is changed.

9. The method according to claim 8, wherein the critical residence time T_x_max is increased by reducing, the temperature of at least one build material for at least a certain period of time.

10. The method according to claim 1, wherein the adaptation comprises a plurality of adaptations, wherein several adaptations are combined with each other.

11. The method according to claim 1 wherein at least one of at least one monitoring of the resulting residence times t_x and at least one of the flow properties of the build materials is carried out during the production of the component.

12. The method according to claim 11, wherein if at least one resulting residence time t_x exceeds the corresponding critical residence time T_x_max of a build material or if the flow properties of at least one build material change, the build material is discharged or new build material is provided or the build material is discharged and new build material is provided.

13. The method according to claim 11, wherein at least one flushing process is initiated if at least one of the following occurs:
at least one resulting residence time t_x exceeds the corresponding critical residence time T_x_max of a build material,
if the flow properties change.

14. A machine controller for a machine for processing plastics materials and other plasticizable materials, wherein the machine controller configured to carry out the method according to claim 1.

15. A machine for processing plastics and other plasticizable materials, wherein the machine is configured to carry out the method according to claim 1.

16. A computer program product comprising a program code stored on a computer-readable medium for carrying out the method according to claim 1 with a machine for processing plastics and other plasticizable materials.
